(19) United States
(12) Patent Application Publication
(10) Pub. No.: US 2007/0194150 A1
(43) Pub. Date: Aug. 23, 2007

(54) COMBINED VALVE, FILTER, AND REGULATOR IRRIGATION APPARATUS

(75) Inventors: Kent C. Ericksen, Centerville, UT (US); Tres Wangsgaard, Holladay, UT (US); Scott Johnson, Woods Cross, UT (US)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Orbit Irrigation Products, Inc., Bountiful, UT (US)

(21) Appl. No.: 11/737,029

(22) Filed: Apr. 18, 2007

Related U.S. Application Data
(63) Continuation-in-part of application No. 11/254,187, filed on Oct. 19, 2005.

(51) Int. Cl. B05B 1/30; B05B 15/10; B01D 35/00; B01D 39/00

(52) U.S. Cl. 239/575; 239/205; 210/455; 210/483

(57) ABSTRACT

A singular combination irrigation apparatus may be used to combine the function of a regulator, valve, and filter into a singular combination, rather than merely connecting the three separate devices together. The irrigation apparatus may include a unitary manifold through which water may flow. This unitary manifold may include a valve-receiving portion and a filter-receiving portion. The valve-receiving portion is positioned upstream of the filter-receiving portion. The irrigation apparatus also includes a filter assembly removably secured to the filter-receiving portion. The irrigation apparatus further includes a valve removably secured to the valve-receiving portion. The manifold may also be manufactured or molded as a single, unitary piece.

### CROSS-REFERENCED RELATED APPLICATIONS

This application is a continuation-in-part of prior U.S. patent application Ser. No. 11/254,187 filed Oct. 19, 2005. This prior application is incorporated herein by reference.

### BACKGROUND OF THE INVENTION

There are many types of irrigation systems known in the art. These irrigation systems generally include irrigation devices, which may be sprinklers, drip emitters, etc. These irrigation devices will generally distribute water to an area such as on a lawn, in a garden, etc. so that grass and other plants may grow. Of course, in order to provide water to the irrigation devices, the irrigation devices are used with a system of arterial pipes. Water is generally delivered to the irrigation devices via the system of pipes. Generally, this system of irrigation devices and pipes are referred to as a “sprinkler system.”

Several types of additional devices may be used as part of the sprinkler system. One such device is a flow regulator. The flow regulator is sometime referred to as a “pressure regulator.” As is known in the industry, the pressure of the water flowing through the pipes may vary and even surge. Such variations in the water pressure depend upon the diameter of the pipes, the amount of water flowing through the pipes, the water source, etc. Obviously, large surges in the water pressure in the pipes can be disadvantageous because if the pressure becomes too high, the pipes may burst. Further, large surges of water pressure may cause the sprinklers themselves to break or malfunction. Accordingly, a pressure regulator is often added to the sprinkler system. This pressure regulator controls and regulates the pressure of the water in the pipes to ensure that pressure is maintained within an acceptable range.

Another type of device that is often used in a sprinkler system is a filter. The filter is a device that removes debris, sediment, rocks, pebbles, dirt, and containments from the irrigation water. The amount of debris present in the irrigation water will depend, in large part, on the source of the irrigation water. Such debris, if it is allowed to enter the sprinklers, can clog the sprinkler, thereby preventing the sprinkler from operating properly. Such clogging of the sprinklers can also result in water leakage, water loss, or cause the sprinkler to unevenly distribute water. Thus, in order to prevent debris from affecting the sprinkler system, a filter is used to remove such debris.

In order to control the sprinkler system, a valve is also used. The valve is a device that can open to allow water to pass through the pipes. The valve can also close to prevent the flow of water. The valve may be connected to an electric timer (or controller) that will automatically open and close the valve at pre-selected times. Thus, the owner can use the combination of the valve and timer to irrigate while the owner is on vacation, to water automatically during the night-time hours, to automatically water at set intervals (such as every three days), etc. The use of such valves/timers is well known and such devices are incorporated into almost all conventional sprinkler systems.

In many conventional sprinkler systems, the individual sprinklers will be divided into “zones” or lines. Each zone of sprinklers will be attached to a separate valve. Thus, the typical sprinkler system will contain multiple valves. The valves allow the user to turn on and off a particular zone of sprinklers as desired.

Generally, the multiple valves will be grouped together in a “sprinkler box” that is placed in the ground. The sprinkler box allows the valves to be buried under the ground and hidden from sight, and also allows the valves to be protected from any accidental damage that may occur if they were placed above ground. At the same time, the placement of the valves in a sprinkler box allows the user access to all of these devices at the same time without requiring the user to go to different locations. The user may desire to access the valves for routine maintenance of the sprinkler system, to fix leaks, etc. For purposes of standardization, the sprinkler boxes are typically made only in two specific sizes, namely a twelve inch (12″) box and a twenty inch (20″) box.

Some users may desire to place the filter and/or the flow regulator also in the sprinkler box. In fact, each zone of sprinklers may have its own filter and/or flow regulator positioned proximate the valve.

FIG. 1 shows a prior art assembly that incorporates a valve 8, a filter 6, and a flow regulator 4 all used together. This combination of devices (represented by number 1) may be positioned in sprinkler box. Sprinkler pipe 10 is positioned between each device. In this configuration, the water enters the combined system of devices though an inlet 2 and then flows to the valve 8. If the valve 8 is open, the water flows through the filter 6 and then to the regulator 4 where the water flows out the exit 12. If the valve 8 is closed, the water is not released past the valve 8.

FIG. 1 shows a common configuration where these three irrigation devices are placed as close as possible to each together to conserve space, yet far enough apart so they operate as intended while allowing a user to access each device (i.e., for replacement). Even so, the length of the combined devices 1 generally is more than twelve inches (12″) and, as depicted in FIG. 1, is about fourteen inches (14″). With such lengths, the irrigation box that must be used to enclose the three combined devices is the twenty inch (20″) size. Using the twelve inch (12″) box does not leave much (if any) room in the irrigation box for the user to install and/or replace any of the three individual devices, making installation and replacement difficult. However, the twenty inch (20″) inch box is much more expensive than the twelve inch (12″) box, and as such, the cost of the sprinkler system greatly increases. Another disadvantage with the three connected devices, as shown in FIG. 1, is that there are multiple connections between the three irrigation devices. Such multiple connections can result in multiple leakage failure points.

Accordingly, there is a need for a new type of irrigation apparatus that incorporates a flow regulator, a valve, and a filter, and may be used with a conventional twelve inch (12″) sprinkler box. Such a device is disclosed herein.

### BRIEF SUMMARY OF THE INVENTION

The invention relates to an irrigation apparatus and methods for making this apparatus. The irrigation apparatus combines the function of a regulator, valve, and filter into a singular combination, rather than merely connecting the three separate devices.

The irrigation apparatus includes a unitary manifold through which water may flow. The manifold generally includes an inlet and an outlet. Specifically, water will enter the manifold via the inlet, flow through the manifold, and then exit the manifold via the outlet. Both the inlet and the outlet will generally include threads that allow the manifold to be attached to other pipes and/or sprinkler components.

The manifold includes a valve-receiving portion that is designed/shaped to receive a valve. In other words, the valve will be removably secured to and/or will fit into the valve-receiving portion. The valve is designed to turn on and off the flow of water through the manifold.

If the valve is open, the water flow through the valve and out of the valve-receiving portion and will enter the filter-receiving portion. The filter-receiving portion directs the flow of water into the filter assembly. The filter-receiving portion is a portion or section of the manifold that is designed to receive a filter assembly. The filter assembly is a device that is capable of filtering/screening the irrigation water. Such filtering of the water removes debris or other contaminants so that such debris does not clog or cause damage to the system.

A filter support insert is also used with the filter assembly. The filter support insert is designed to support the filter assembly. The filter support insert is designed such that it may be positioned within the filter-receiving portion. Because the filter support insert is made separate from manifold and is positioned within manifold to receive and re-direct the flow of water, the manifold may be constructed as a unitary piece. When the water flows into the filter-receiving portion, the filter support insert re-directs the water into the filter assembly. More specifically, the filter support insert may include a fluid tube that may be positioned in the water flow path. A re-directing wall may be positioned at the end of the tube. The re-directing wall directs the water out of the fluid pathway and into the filter assembly. Once in the filter assembly, the water flows through the filter. In some embodiments, the filter is a mesh screen or other water-permeable membrane. After flowing through the filter, the water is returned to the filter-receiving portion downstream of where the water enters the fluid tube and is allowed to exit the filter-receiving portion.

The manifold further includes a regulator-receiving portion. The regulator-receiving portion is positioned downstream of the filter-receiving portion. Thus, once the water exits the filter-receiving portion, it may flow into the regulator-receiving portion. A flow regulator is positioned in the regulator-receiving portion. The flow regulator is a device that is capable of adjusting the pressure of the water flowing within the manifold so that water pressure is maintained within the desired range. After flowing through the flow regulator, the water flows out of the manifold via the outlet.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side elevation view that depicts a prior art irrigation apparatus that includes a valve, a filter, and flow regulator;

FIG. 2 is an exploded assembly view of an irrigation apparatus according to the present embodiments;

FIG. 3 is a perspective view of a manifold that is used as part of the of the irrigation apparatus of FIG. 1;

FIG. 3A is a cutaway sectional view of the valve-receiving portion of FIG. 2;

FIG. 4 is a perspective view of a filter support insert that is used as part of the of the irrigation apparatus of FIG. 1 showing how a filter may be inserted therein;

FIG. 5 is a longitudinal cutaway perspective view that shows the irrigation apparatus of FIG. 2 when it is fully assembled; and

FIG. 6 is a perspective view that illustrates one embodiment of a mold that may be used to create an embodiment of a manifold used in the irrigation apparatus.

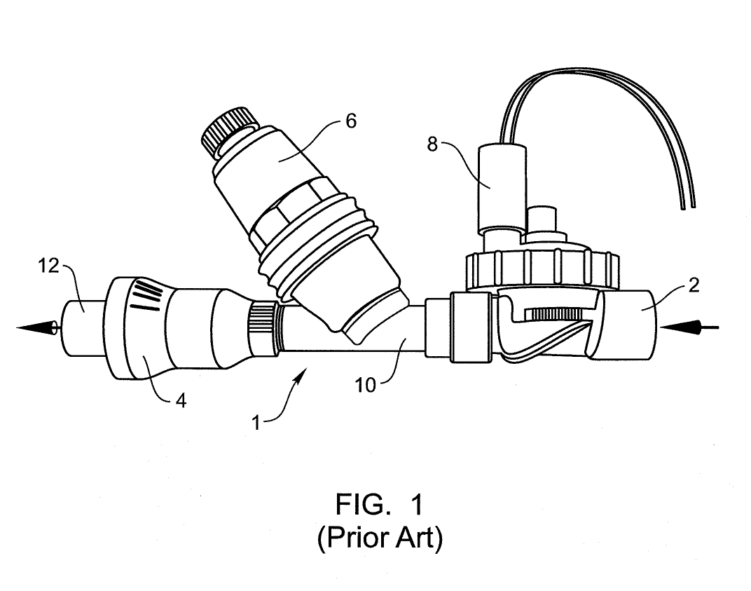

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

A singular combination irrigation apparatus is disclosed. This irrigation apparatus comprises a unitary manifold through which water may flow. The unitary manifold may be less than twelve inches (12″) in length. The manifold also comprises a valve-receiving portion and a filter-receiving portion. The valve-receiving portion is positioned upstream of the filter-receiving portion. A valve is also added to the irrigation apparatus. The valve is removably secured to the valve-receiving portion. The valve may comprise a solenoid for turning on and off the flow of water through the manifold.

A filter assembly is added to the irrigation apparatus. The filter assembly is removably secured to the filter-receiving portion. The filter assembly 240 may also be affixed to the filter-receiving portion, via glue or other means. If the filter assembly 240 is affixed via gluing, this component may (in some embodiments) not be removable. The filter assembly may comprise a housing and a cap, wherein the cap is removably secured to the housing, wherein removal of the cap provides access to the interior of the housing. In other embodiments, the filter assembly and the valve may be transverse to the manifold. Further embodiments may be designed in which the filter assembly and the valve are substantially perpendicular to the manifold. It should be noted that existing standard valves or existing standard filters may be used as the valve/filter assembly, as desired.

The manifold may further comprise a regulator-receiving portion downstream of the filter-receiving portion. A flow regulator may be removably secured to the regulator-receiving portion. The flow regulator may be designed to control the flow of water within a pressure range of about 15 psi to about 100 psi.

The present embodiments also include a filter support insert. The filter support insert is used as part of the irrigation apparatus. The filter support insert is removably disposable within the filter-receiving portion. The filter support insert is designed to direct the flow of water from the manifold into the filter assembly. In some embodiments, the filter support insert comprises a tube that fits into the filter-receiving portion. The filter support insert also comprises a circumferential ring into which the filter assembly may fit. Further, the filter support insert comprises a re-directing wall that directs the water into the filter assembly. The filter assembly may comprise a filter supported by the filter support insert. The flow of water may be directed from the unitary manifold to the filter, and then after flowing through the filter, the water may be returned to the manifold downstream of the filter support insert.

The present embodiments also relate to a method for making an irrigation apparatus. The irrigation apparatus comprises a unitary manifold through which water may flow. The method includes the steps of inserting a first rod and a second into a mold, wherein the rods define a flow path. In some embodiments, the step of molding the manifold may also be performed. The molded manifold comprises a valve-receiving portion and a filter-receiving portion, the valve-receiving portion being positioned upstream of the filter-receiving portion. Finally, the step of removing the rods may also be performed.

In other embodiments, the step of forming a filter support insert may be performed. After the filter support is formed, the step of inserting the filter support insert into the filter-receiving portion may be performed. Because the irrigation apparatus may comprise a valve, the step of removably securing the valve to the valve-receiving portion may be performed. Similarly, because the irrigation apparatus may comprise a filter assembly, the step of removably securing the filter assembly to the filter-receiving portion may be performed. Because the irrigation apparatus may comprise a flow regulator, the step of removably securing the flow regulator to the regulator-receiving portion may further be performed.

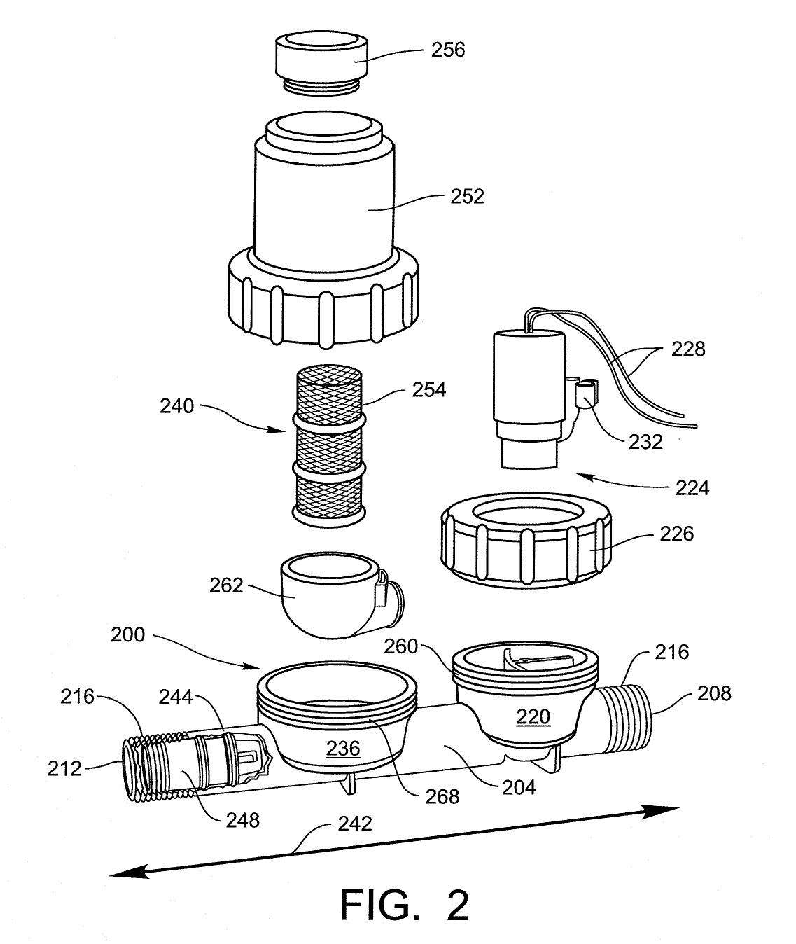

Referring now to FIG. 2, an exploded assembly view of a singular combination irrigation apparatus 200 according to the present embodiments is shown. The irrigation apparatus 200 is a device that combines the function of a flow regulator, valve, and filter into a single unit, rather than merely connecting the three separate devices. Incorporating the functions of the three separate devices into a single unit allows a smaller size to be used, making it quicker and easier to install and/or replace in the limited space provided by irrigation boxes. Also, less leakage occurs because there are fewer connections. Using a single apparatus 200 alternatively allows a smaller irrigation box to be used, saving on costs.

The irrigation apparatus 200 includes a unitary manifold 204 through which water may flow. This manifold 204 will generally be a pipe or tube made of PVC, plastic, thermoplastic, metal, or other similar materials common in the sprinkler/irrigation industry. The manifold 204 generally includes an inlet 208 and an outlet 212. Both the inlet 208 and the outlet 212 will generally include threads 216 that allow the manifold 204 to be attached to (i.e., screwed together) other pipes and/or sprinkler components. The threads 216 may be “male threads,” as shown in FIG. 2, such that the inlet 208 and the outlet 212 may be inserted/screwed into another pipe. Of course, other embodiments may be designed in which the threads 216 are “female threads,” which would allow another pipe to be inserted/screwed into the outlet 212/inlet 208.

Once the manifold 204 has been connected to the sprinkler pipes, water may flow through the manifold 204 as part of the sprinkler system. Specifically, water will enter the manifold 204 via the inlet 208, flow through the manifold 204, and then exit the manifold via outlet 212.

The manifold 204 includes a valve-receiving portion 220. The valve-receiving portion 220 is positioned proximate the inlet 208. The valve-receiving portion 220 is designed to receive a valve 224. In other words, the valve 224 will be attached to and/or will fit into the valve-receiving portion 220. The valve-receiving portion 220 includes threads 260 such that the valve 224 may be removably secured to the valve-receiving portion 220. As shown in FIG. 2, the valve-receiving portion is a circular area that is designed to receive the valve 224. Other shapes and/or configurations for the valve-receiving portion 220 may also be used.

The valve 224 is a solenoid valve, a “double diaphragm” valve, or other similar device that is capable of sealing the manifold 204. In other words, the valve 224 is designed to turn on and off the flow of water through the manifold 204. Any type of valve known in the art may be used. The particular valve used may depend upon the size and dimensions of the manifold 204/valve-receiving portion 220. The valve may include a housing 226 that attaches to the threads 260 to secure the valve 224 to the valve-receiving portion 220.

In operation, water enters the manifold 204 via the inlet 208 and flows into the valve-receiving portion 220. The valve 224 contains an obstruction to the water flow that may be in an open position or a closed position. If the valve 224 is in an open position, the water will be able to continue flowing through the manifold 204. However, if the valve 224 is in the closed position, the valve 224 will seal the manifold 204/valve-receiving portion 220, thereby blocking the flow of water any further. This type of valve is known in the art and those skilled in the art will understand how the valve 224 may be configured to turn the flow of water on and off. The valve 224 may further include electrical wires 228 that connect the valve 224 to a timer or control box (not shown). This timer/control box will allow the user to open and close the valve 224 at specified times. A manual switch 232 may also be added to the valve 224 that may allow a user to manually open and close the valve, as desired.

The manifold 204 also includes a filter-receiving portion 236. If the valve 224 is open, the water flows out of the valve-receiving portion 220 and will enter the filter-receiving portion 236. The filter-receiving portion 236 directs the flow of water into the filter assembly 240. The filter-receiving portion 236 is a portion or section of the manifold 204 that is designed to receive a filter assembly 240. In some embodiments, the filter-receiving portion 236 may include threads 268 which allow the filter assembly 240 to be removably secured to the filter-receiving portion 236. In other embodiments, the filter assembly 240 may be affixed to the filter-receiving portion 236 (such as by gluing). In the embodiment of FIG. 2, the filter-receiving portion 236 is a rounded area into which a filter assembly 240 is attached. Of course, other configurations, shapes and sizes of both the filter assembly 240 and the filter-receiving portion 236 may be used.

The filter assembly 240 is a device that is capable of filtering/screening the irrigation water. Such filtering of the water removes debris, pebbles, dirt, or other contaminants so that such debris does not clog or cause damage to the system. Any type of device or assembly that is capable of filtering/removing debris from the water may be used as the filter assembly 240, including filter devices that are commercially available. The exact specifications and size of this device will depend upon a variety of factors, including the type and amount of debris to be removed.

The particular embodiment of the filter assembly 240 shown in FIG. 2 will now be described. Specifically, the filter assembly 240 may include a filter housing 252 and a filter 254. The filter housing 252 surrounds and houses the filter 254. A cap 256 may be removably secured to the housing 252 (via threads, etc.). If a user want access to the interior of the housing 252 (such as to clean or change the filter 254), the user may simply remove (unscrew) the cap 256 from the housing 252.

A filter support insert 262 is also used with the filter assembly 240. The filter support insert 262 is designed to support the filter assembly 240. The filter support insert 262 is designed such that it may be positioned within the filter-receiving portion 236.

It should be noted that, as shown in FIG. 2, both the filter assembly 240 and/or the valve 224 are transverse to the manifold 204. In other embodiments, the filter assembly 240 and/or valve 224 are perpendicular or substantially perpendicular to the longitudinal axis 242 of the manifold 204. The perpendicular or substantially perpendicular disposition of valve 224 and filter assembly 240 allows the user to easily access these components for repair or replacement. (In some embodiments, the flow of the water through the manifold 204 will be substantially parallel the longitudinal axis 242). When the filter assembly 240/valve 224 are traverse or substantially perpendicular, both the filter assembly 240 and the valve 224 to be straight up and down, when the apparatus 200 is positioned in a sprinkler box. Other embodiments may be designed in which the filter assembly 240 and/or the valve 224 have other shapes, configurations, and/or are not transverse, perpendicular, or substantially perpendicular to the axis 242/manifold 204.

After being filtered by the filter assembly 240, the water flows into a regulator-receiving portion 244 positioned in the manifold 204 as shown in cutaway in FIG. 2. The regulator-receiving portion 244 is positioned downstream of the filter-receiving portion 236. The regulator-receiving portion 244 is an area or section of the manifold 204 that is designed to receive or engage a flow regulator 248. As shown in FIG. 2, the regulator-receiving portion 244 is an area of the manifold 204 that is positioned inside the manifold 204 proximate the outlet 212. Other embodiments may be designed in which the regulator-receiving portion 244 is a circular area (similar to the filter-receiving portion 236). Other sizes, shapes, and configurations that are capable of receiving a flow regulator 248 may be used as the regulator-receiving portion 244.

The flow regulator 248 is also positioned within the manifold 204. The flow regulator 248 is a device that is capable of adjusting the pressure of the water flowing within the manifold 204 and within the sprinkler system. In some embodiments, the flow regulator 248 will ensure that the pressure of the water is plus or minus 15 psi, thereby keeping the pressure within a range of about 15 psi to about 60 psi. A variety of different devices may be used as the flow regulator 248, including those devices that use a spring and its deflection to absorb energy and reduce pressure. Other types of flow regulators 248 may vary in length, thereby adjusting the size of a water flow opening, as a means of regulating/adjusting the water pressure.

When the flow regulator 248 is positioned inside the manifold 204, the apparatus 200 provides a device that combines the function of a flow regulator, valve, and filter into a single, compact unit. In fact, in some embodiments, this length of the apparatus 200 will be less than inches (12″). In other embodiments, the length of the apparatus 200 is between 8 and 9 inches (such as about 8.5 inches or 9.5 inches). This small, compact device means that the apparatus 200 may readily be used with a smaller, twelve inch (12″) sprinkler box, rather than a more expensive (larger) twenty inch (20″) sprinkler box. Further, because of the compact nature of the apparatus 200, it is possible to position multiple units of the apparatus 200 within a single sprinkler box.

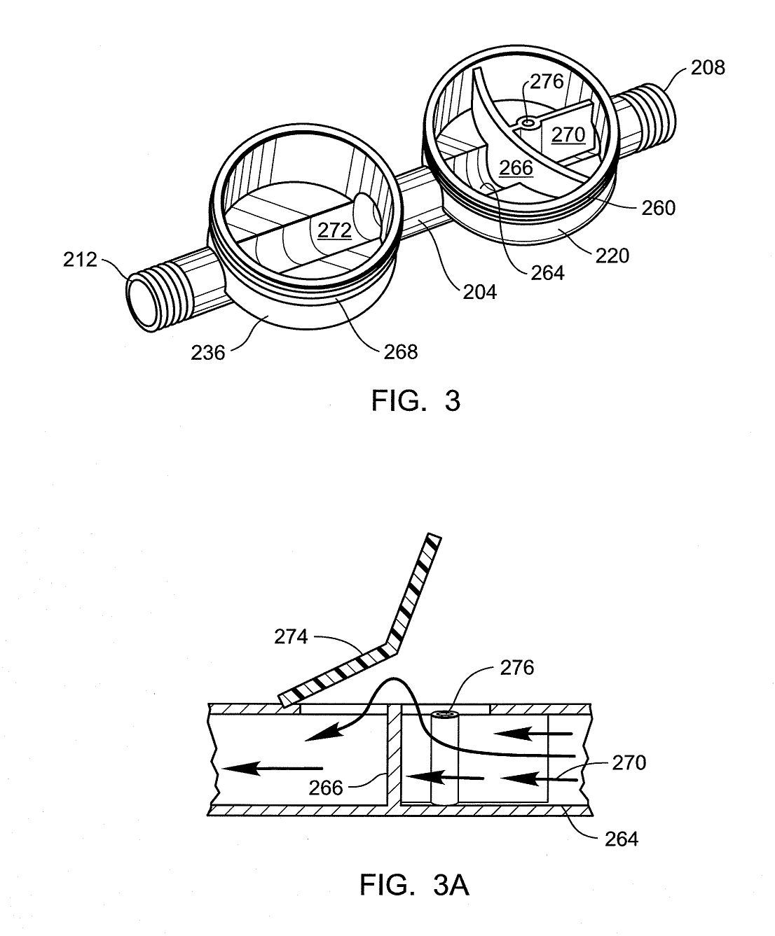

Referring now to FIG. 3, a perspective view of the unitary manifold 204 is illustrated in which the filter assembly 240, the flow regulator 248, and the valve 224 have been removed for clarity. FIG. 3 shows the manifold 204 as it is initially manufactured/molded. As will be described in detail herein, the manifold 204, as shown in FIG. 3, may be molded as a single unitary piece.

As shown in FIG. 3, the valve-receiving portion 220 may comprise a circular, molded section that is sized to match the size of the valve 224 (not shown in FIG. 3). Threads 260 may be added around the exterior of the valve-receiving portion 220. These threads engage corresponding threads that are positioned on the valve 224. Thus, the valve 224 may be screwed onto the valve-receiving portion 220.

A fluid passageway 264 passes through the valve-receiving portion 220. This fluid passageway 264 is part of the water flow path through which the water will flow as it passes through the manifold 204. The valve-receiving portion 220 may include a sealing wall 266. The sealing wall 266 may be transverse to the fluid passageway 264. The sealing wall 266 may also be curved. A parallel wall 270 may also be positioned in the valve-receiving portion 220. The parallel wall 270 may contact the sealing wall 266. A hole 276 may be added to the wall 270. This hole 276 may be designed to receive a portion of the valve 224 so that the valve 224 is centered and securely fits into the valve-receiving portion 220.

Referring now to FIGS. 3 and 3A collectively, one way in which the valve 224 may operate to turn off the water flow will now be described. As the water flows through fluid passageway 264, the water flow will be forced up into the valve 224. (In FIG. 3A, arrows represent the flow of the water in the passageway 264.) The valve 224 may include a closing member 274. The closing member 274 may be opened or closed. If the member 274 is in the closed position, the valve 224 will block/impede the flow of the water through the passageway 264, thereby turning off the flow of water. However, when the member 274 is open (as shown in FIG. 3A), the valve 224 will not totally block the flow of water through the passageway 264. Rather, when the valve 224 is open, water will pass through the passageway 264.

It should be noted that the embodiment shown in FIGS. 3 and 3A are given as exemplary embodiments of the way in which the valve 224 may be used to selectively turn on and off the water flow. Other types of valves 224 may be used. Of course, if other types of valves are used, different features, elements, etc. may be positioned as part of the valve-receiving portion 220 or fluid passageway 264.

Referring again to FIG. 3, the filter-receiving portion will now be described. The filter-receiving portion 236 may comprise a circular, molded section that is sized to match the size of the filter assembly 240 (shown in FIG. 2). Threads 268 may be added around the exterior of the filter-receiving portion 236. These threads engage corresponding threads that are positioned on a filter housing (not shown in FIG. 3). The filter assembly 240 may be screwed onto the filter-receiving portion 236.

A fluid passageway 272 passes through the filter-receiving portion 236. This fluid passageway 272 is part of the water flow path through which the water will flow as it passes through the manifold 204. As the water flows through the fluid passageway 272, the water flow will be re-directed through the filter assembly 240. After being filtered by the filter assembly 240, the water flow will be returned to the passageway 272 so that the water may continue to flow the manifold 204 and may exit the manifold via the outlet 212.

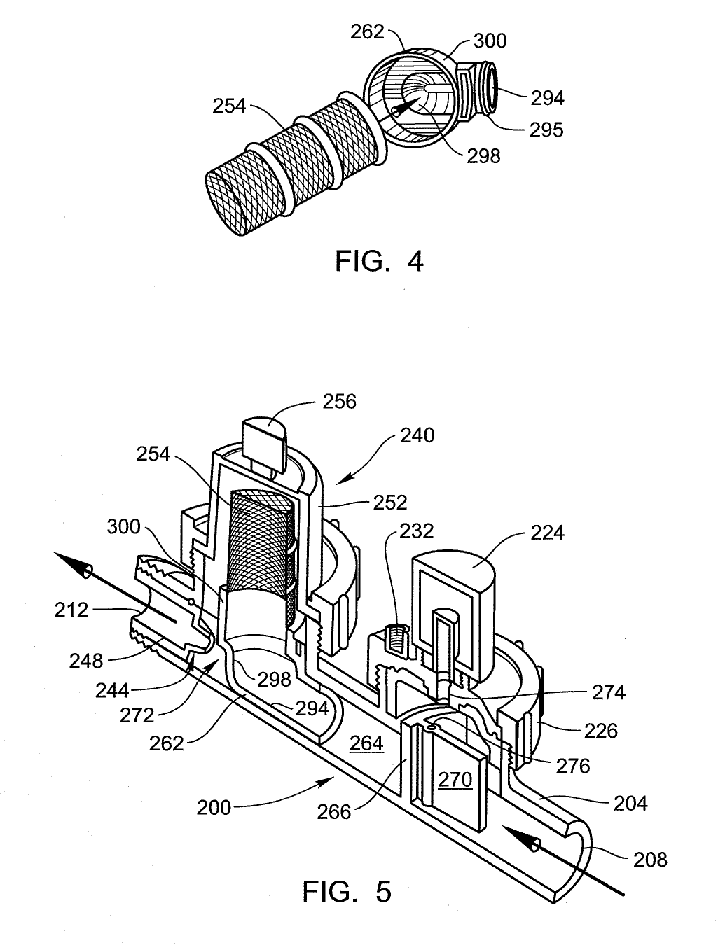

FIG. 4 is a perspective view of a filter support insert 262 and the filter 254. In conjunction with FIGS. 3 and 4, the filter support insert 262 will now be described. The filter support insert 262 is designed to support the filter assembly 240 (not shown in FIG. 4). In other words, the filter assembly 240 will engage and/or be supported by the filter support insert 262.

The filter support insert 262 may comprise a component of the apparatus 200. The filter support insert 262 includes a fluid tube 294. The fluid tube 294 is a member designed such that it may be positioned in water-tight engagement within the fluid passageway 272 (shown in FIG. 3). Additionally, an O-ring 295 may be used to seal the filter support insert 262 against the interior wall of the passageway 272. When the fluid tube 294 is positioned in the passageway 272, the water will flow from the fluid passageway 272 into the fluid tube 294. In some embodiments, the fluid tube 294 is designed such that it will tightly fit within the fluid passageway 272. Accordingly, when properly positioned, friction holds the fluid tube 294 within the passageway 272, even when the water is flowing.

The filter support insert 262 also includes a re-directing wall 298 that is positioned at the end of the fluid tube 294. The re-directing wall 298 is designed to re-direct the flow of the fluid as the water flows through the tube 294. Any member, structure, or wall that is capable of re-directing the water flow may be used as the re-directing wall 298. The re-directing wall 298 directs the water out of the passageway 272/tube 294 into the filter assembly 240 (now shown in FIG. 4). In embodiment of FIG. 4, the re-directing wall 298 is a wall that causes the water flow to move upwards out of the tube 294.

A circumferential ring 300 is also added to the filter support insert 290. The circumferential ring 300 is a circular wall that is designed to surround and hold the filter 254. The filter 254 is one of the components of the filter assembly 240. As can be seen in FIG. 4, the filter 254 comprises a cylindrical column. The diameter of the filter 254 is less (or slightly less) than the diameter of the ring 300. Accordingly, the filter 254, when properly positioned, will be held in its proper position—i.e., inside of the circumferential ring 300. Again, an O-ring may be used on the filter 254 to assist in securing the filter 254 to the ring 300 in water-tight engagement.

The filter 254 may be constructed of plastic or other similar materials. Of course, the filter 254 may include a mesh screen or other similar membrane that is permeable to water. In the embodiment shown in FIG. 4, only a portion of the filter 254 actually comprises the mesh screen. In other embodiments, the mesh screen will extend along all or portion of the entire height of the filter 254.

When the filter support insert 262 is properly positioned in the manifold, the fluid tube 294 is positioned within the passageway 272. Accordingly, the water flows from the passageway 272 into the tube 294. After flowing through the tube 294, the water will contact the re-direction wall 298. Such contact with the re-directing wall 298 re-directs the water flow into the filter 254. As shown in FIG. 4, the re-directing wall 298 directs the water upwards into the filter 254. The water then flows outwards through the filter 254. Of course, as the water flows through the filter 254, all debris, pebbles, dirt, etc. are trapped on the interior surface of the filter 254 such that this particles/debris are removed from the water flow.

Referring now to FIG. 5, a longitudinal cutaway perspective view shows the irrigation apparatus 200 when it is fully assembled. As explained above, the valve 224 controls the flow of the water. If the valve 224 is open, water flows into the filter-receiving portion 236 (shown in FIG. 2) and more specifically into the fluid passageway 272. As noted above, the filter support insert 262 is positioned in the fluid passageway 272. Accordingly, when the water is in the fluid passageway 272, the water will be directed into the filter support insert 262.

In turn, the filter support insert 262 directs the water into the filter assembly 240 (in the manner described above). After the water flows through the filter 254, the filtered water the returns the fluid passageway 272. In the embodiment shown in FIG. 5, the water flows outward through the filter 254 such that, once filtered, is outside of the circumferential ring 300. Once the water flow is outside of the circumferential ring 300, the water flows downward until it returns to the passageway 272.

Once the water returns to the passageway 272, the water flow exits the filter-receiving portion 236 and flows into the regulator-receiving portion 244 and into the flow regulator 248. The flow regulator 248 regulates the water pressure of the flow. After flowing through the regulator 248, the water flows out of the manifold 204 via the outlet 212.

As can be seen from the FIG. 5, the singular combination irrigation apparatus 200 provides the irrigation functions of a flow regulator, valve, and filter into a single unit, rather than merely connecting the three separate devices. Thus, the present apparatus allows for a smaller size to be used, making it quicker and easier to install and/or replace in the limited space provided by irrigation boxes.

Embodiments may also be designed in which the filter assembly 240 and/or the valve 224 are replaceable. In other words, if the valve 224 or the filter assembly 240 fails or becomes inoperable, each of these devices may be replaced without the need to replace the manifold or without the need to remove the manifold from the sprinkler system. A user is simply required to obtain/purchase a new filter assembly and/or a valve. The new filter assembly and/or new valve may be commercially available devices. Thus, the failed valve may simply be unscrewed from the valve-receiving portion 220 and the new valve screwed into position. Similarly, the failed filter assembly may simply be unscrewed from the filter-receiving portion 236 and the new filter assembly screwed into position.

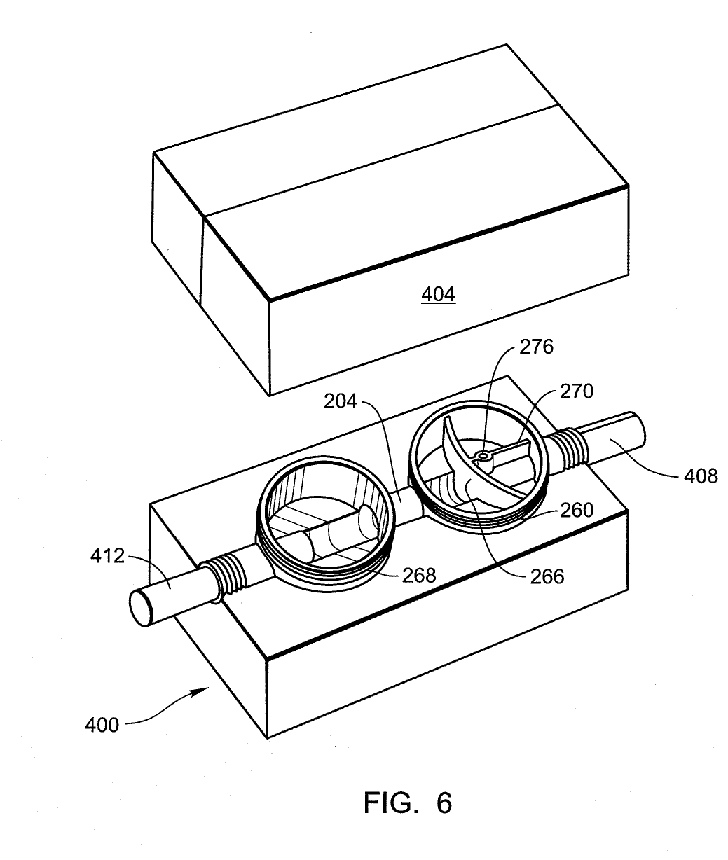

Referring now to FIG. 6, a perspective view shows a mold 400 that may be used to mold the manifold 204 of the irrigation apparatus 200 of the present embodiments. In conjunction with this figure, one embodiment of the way in which the manifold 204 may be manufactured will now be described. However, it is noted that a variety of different manufacturing methods may be used.

FIG. 6 shows a mold 400 having a lid 404. The mold 400 is formed and shaped to form the manifold 204. A first rod 408 and a second rod 412 are also used as part of the molding process. Specifically, as part of the manufacturing process, the first rod 408 and the second rod 412 are inserted into the mold 400. The purpose of the rods 408, 412 is to form the flow path (i.e., the fluid passageway). In other words, by inserting the rods 408, 412 prior to filling the mold 400 with material, the rods 408, 412 ensure that there is a fluid flow path (channel) through which the water will flow.

It should be noted that embodiments may be constructed in which the first rod 408 and the second rod 412 are not inserted equal distances into the mold 400. In other words, embodiments may be constructed in which the first rod 408 is inserted a greater distance into the mold 400 than is the second rod 412. Other embodiments may be designed in which the second rod 412 is inserted a greater distance than the first rod 408. The exact way and/or configuration of the rods 408, 412 after they have been inserted into the mold 400 will depend upon the particular embodiment. However, the rods 408, 412 should be designed such that they form a fluid passageway (flow pathway) for the water flow.

After the rods 408, 412 have been inserted, the mold 400 is filled with material. This material may be a molten material such as a plastic, a thermoplastic, PVC, etc. Once the mold is filled, the lid 404 may be closed and the manifold 204 molded as a unitary piece. After the manifold 204 has been molded, the lid 404 may be opened and the rods 408, 412 removed. Once the rods 408, 414 are removed, the manifold 204 may be removed from the mold 400. In other embodiments the rods 408, 412 will be removed after the manifold 204 has been removed from the mold.

It should be noted that the mold 400 and the lid 404 may be designed and shaped such that when used, the mold 400 produces the manifold 204 with all of the details and intricacies disclosed herein. Such details may include the shape of the filter-receiving portion 236, the shape of the valve-receiving portion 220, the inclusion of the threads 268, 260, the sealing wall 266, and/or other feature/element of the manifold 204. Those skilled in the art will understand how the mold 400 and/or the lid 404 may be shaped/configured to produce the manifold 204.

In some embodiments, the first or second rod 408, 412 may include a slot (not shown) into which material may be inserted. The position and shape of the slot is designed so that during the molding process, the parallel wall 270 (not shown in FIG. 2) may be formed. More specifically, during the molding process, material will enter the slot and will be molded into the parallel wall 270 that is positioned in the flow path.

Referring now to all of the Figures generally, further steps in the manufacturing method will now be described. Once the manifold 400 has been molded, a similar molding process may be used to form the filter support insert 262. A different mold may be used to construct the filter support insert 262. Once the filter support insert 262 has been formed, the method of forming the irrigation apparatus 200 may include the step of inserting the filter support insert 262 into the filter-receiving portion 236. Once the filter support insert 262 is positioned, the step of removably securing the filter assembly 240 to the filter-receiving portion 236 may be performed. Likewise, the step of removably securing the valve to the valve-receiving portion 220 as well as the step of removably securing the flow regulator 248 to the regulator-receiving portion 244 may be performed.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A singular combination irrigation apparatus comprising:
a unitary manifold through which water may flow, the manifold comprising a valve-receiving portion and a filter-receiving portion, the valve-receiving portion being positioned upstream of the filter-receiving portion;
a filter assembly affixed or removably secured to the filter-receiving portion; and
a valve removably secured to the valve-receiving portion.

2. An irrigation apparatus as in claim 1 wherein the manifold further comprises a regulator-receiving portion downstream of the filter-receiving portion.

3. An irrigation apparatus as in claim 2 further comprising a flow regulator removably secured to the regulator-receiving portion.

4. An irrigation apparatus as in claim 3 wherein the flow regulator controls the flow of water within a pressure range of about 15 psi to about 100 psi.

5. An irrigation apparatus as in claim 1 further comprising a filter support insert removably disposable within the filter-receiving portion to direct the flow of water from the manifold into the filter assembly.

6. An irrigation apparatus as in claim 5 wherein the filter support insert comprises:
a tube that fits into the filter-receiving portion;
a circumferential ring into which the filter assembly may fit; and
a re-directing wall that directs the water into the filter assembly

7. An irrigation apparatus as in claim 5 wherein the filter assembly comprises a filter supported by the filter support insert and the water flow is directed from the unitary manifold to the filter and is returned to the manifold downstream of the filter support insert.

8. An irrigation apparatus as in claim 1 wherein the filter assembly comprises a housing and a cap, wherein the cap is removably secured to the housing, wherein removal of the cap provides access to the interior of the housing.

9. An irrigation apparatus as in claim 1 wherein the unitary manifold is about 9.5 inches in length.

10. An irrigation apparatus as in claim 1 wherein the filter assembly and the valve are transverse to the manifold.

11. An irrigation apparatus as in claim 10 wherein the filter assembly and the valve are substantially perpendicular to the manifold.

12. An irrigation apparatus as in claim 1 wherein the valve is a solenoid valve for turning on and off the flow of water through the manifold.

13. A method for making an irrigation apparatus comprising a unitary manifold through which water may flow, wherein the method comprises:
inserting a first rod into a mold;
inserting a second rod into a mold, wherein the rods define a flow path;
molding the manifold comprising a valve-receiving portion and a filter-receiving portion, the valve-receiving portion being positioned upstream of the filter-receiving portion
removing the rods.

14. A method as in claim 13 further comprising the step of forming a filter support insert.

15. A method as in claim 15 further comprising the step of inserting the filter support insert into the filter-receiving portion.

16. A method as in claim 15 wherein the irrigation apparatus further comprises a filter assembly, wherein the method further comprises the step of removably securing the filter assembly into the filter-receiving portion.

17. A method as in claim 13 wherein the irrigation apparatus further comprises a valve, wherein the method further comprises the step of removably securing the valve to the valve-receiving portion.

18. A method as in claim 13 wherein the manifold further comprises a regulator-receiving portion, wherein the method further comprises the step of inserting a flow regulator in the regulator-receiving portion.
